(19) United States
(12) Patent Application Publication
(10) Pub. No.: US 2017/0219005 A1
(43) Pub. Date: Aug. 3, 2017

(54) SHEATH FOR A CABLE FOR A BICYCLE

(71) Applicant: CHIA CHERNE INDUSTRY CO., LTD., Changhua City (TW)

(72) Inventors: Yung-Pin Kuo, Changhua City (TW); Wei-Hung Chang, Changhua City (TW)

(21) Appl. No.: 15/011,282

(22) Filed: Jan. 29, 2016

(51) Int. Cl. F16C 1/26

(52) U.S. Cl. CPC F16C 1/26; F16C 1/267

(57) ABSTRACT

A sheath for a cable for a bicycle includes a tubular lining, a reinforcing tube and a tubular colored layer. The reinforcing tube is provided on the tubular lining. The reinforcing tube includes a tubular plastic layer and a tubular web embedded in the tubular plastic layer. The tubular web includes two groups of helical fibers. The fibers in one group intersect the fibers in the other group. The tubular colored layer is provided on the tubular plastic layer.

### BACKGROUND OF INVENTION

1. Field of Invention

The present invention relates to a bicycle and, more particularly, to a sheath for a bicycle for a bicycle.

2. Related Prior Art

A bicycle includes a braking system that includes a right brake lever, a front brake caliber, a left brake lever, a rear brake caliber, two cables and several sheaths. One of the cables is inserted in one of the sheaths, and includes an end connected to the right brake lever and another end connected to the front brake caliber for example. The other cable is inserted in the other sheaths, and includes an end connected to the left brake lever and another end connected to the rear brake caliber for example. The right brake lever is operable to pull the corresponding cable in the corresponding sheath to close the front brake caliber. The left brake lever is operable to pull the corresponding cable in the corresponding sheaths to close the rear brake caliber. Thus, the bicycle is slowed down.

Referring to FIGS. 9 and 10, a conventional sheath 4 includes a tubular lining 41, a fiber-based layer 42, an internal protective tube 43, a reinforcing tube 44, an external protective tube 45 and a tubular coat 46. The fiber-based layer 42 includes metal fibers 421 arranged in a circular manner. The metal fibers 421 extend longitudinally. The reinforcing tube 44 includes a high polymer fiber 441 extending in a helical manner around the protective tube 43, with a gap between every two adjacent rounds. Thus, the sheath 4 is flexible so that it can be arranged in compliance with the bicycle. As a cable inserted in the sheath 4 is pulled, the metal fibers 421 are compressed longitudinally so that the metal fibers 421 tend to spread. The high polymer fiber 441 of the reinforcing tube 44 holds the metal fibers 421 of the fiber-based layer 42 together. That is, the high polymer fiber 441 of the reinforcing tube 44 reinforces the sheath 4 by preventing the metal fibers 421 of the fiber-based layer 42 from sticking out. The weight of the high polymer fiber 441 is light. However, the single high polymer fiber 441 of the sheath 4 extends around the protective tube 43 has been proven to be inadequate in some cases.

The present invention is therefore intended to obviate or at least alleviate the problems encountered in prior art.

### SUMMARY OF INVENTION

It is an objective of the present invention to provide a sheath that is high in strength.

It is another objective of the present invention to provide a sheath that is light in weight.

It is another objective of the present invention to provide an aesthetic sheath.

To achieve the foregoing objectives, the sheath includes a tubular lining, a reinforcing tube and a tubular colored layer. The reinforcing tube is provided on the tubular lining. The reinforcing tube includes a tubular plastic layer and a tubular web embedded in the tubular plastic layer. The tubular web includes two groups of helical fibers. The fibers in one group intersect the fibers in the other group. The tubular colored layer is provided on the tubular plastic layer.

In another aspect, the fibers in each group are evenly arranged on the tubular lining Any two adjacent ones of the fibers are separated by a gap in each group.

In another aspect, the tubular web includes apertures filled with a plastic material used to make the tubular plastic layer.

In another aspect, the tubular plastic layer is adhered to the tubular lining.

In another aspect, the fibers are made of iron, steel, stainless steel, titanium alloy or copper.

In another aspect, the tubular plastic layer is made of a transparent plastic material or a translucent plastic material.

In another aspect, the tubular plastic layer includes a gloss surface or a matt surface.

In another aspect, the tubular lining is made of a plastic material.

Other objectives, advantages and features of the present invention will become apparent from the following description referring to the attached drawings.

### BRIEF DESCRIPTION OF DRAWINGS

The present invention will be described via detailed illustration of the preferred embodiment referring to the drawings wherein:

FIG. 1 is a perspective view of a combination of a cable with a sheath according to the preferred embodiment of the present invention;

FIG. 2 is an exploded view of the combination shown in FIG. 1;

FIG. 3 is a cross-sectional view of the sheath shown in FIG. 2;

FIG. 4 is an enlarged partial side view of the sheath shown in FIG. 2;

FIG. 5 is another exploded view of the combination shown in FIG. 1;

FIG. 6 is a side view of a bicycle equipped with several sheaths as shown in FIG. 1;

FIG. 7 is a front view of the bicycle shown in FIG. 6;

FIG. 8 is an enlarged partial view of the bicycle shown in FIG. 7;

FIG. 9 is a perspective view of a conventional sheath; and

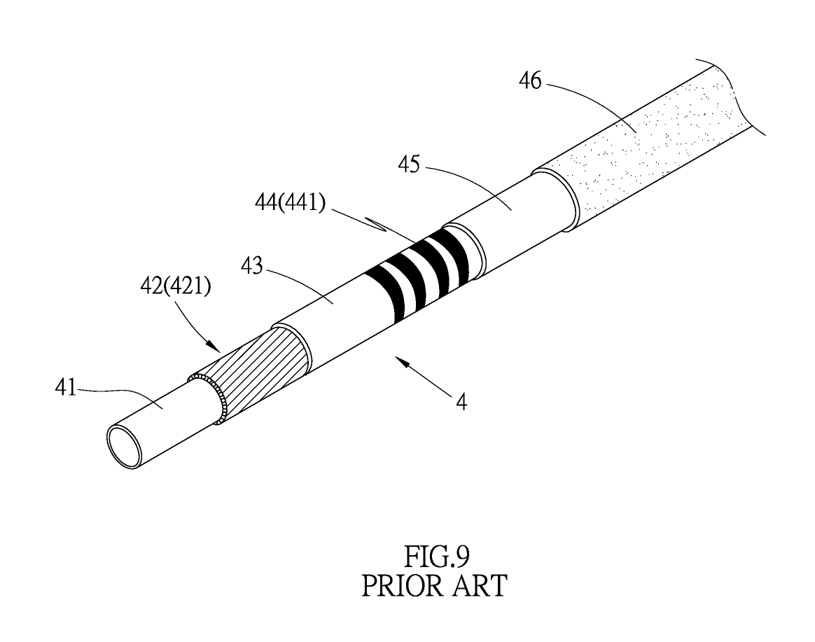

FIG. 10 is a cross-sectional view of the sheath shown in FIG. 9.

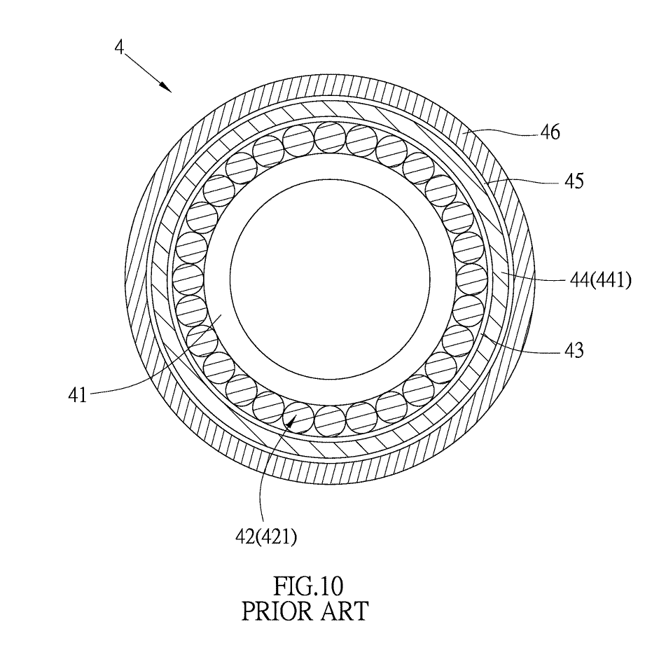

### DETAILED DESCRIPTION OF PREFERRED EMBODIMENT

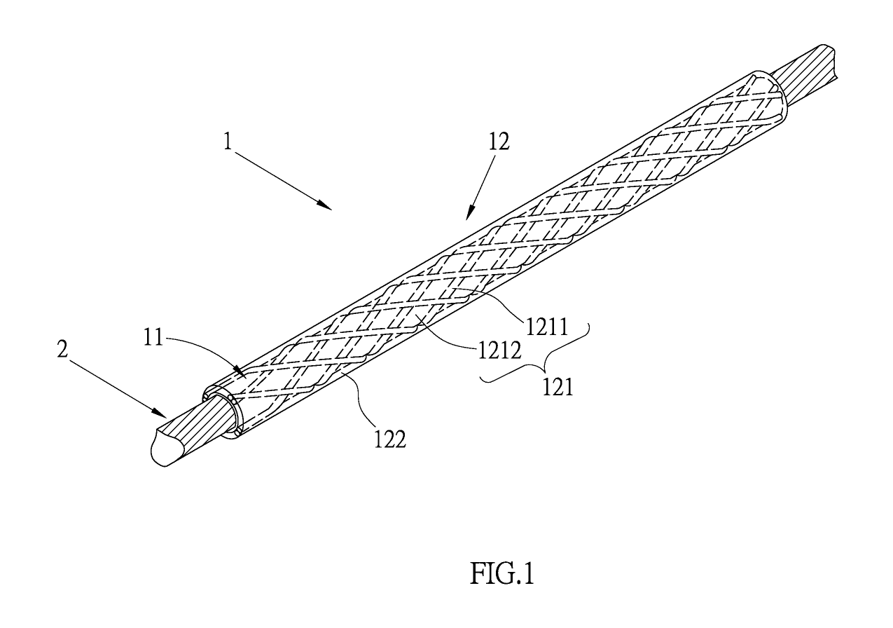

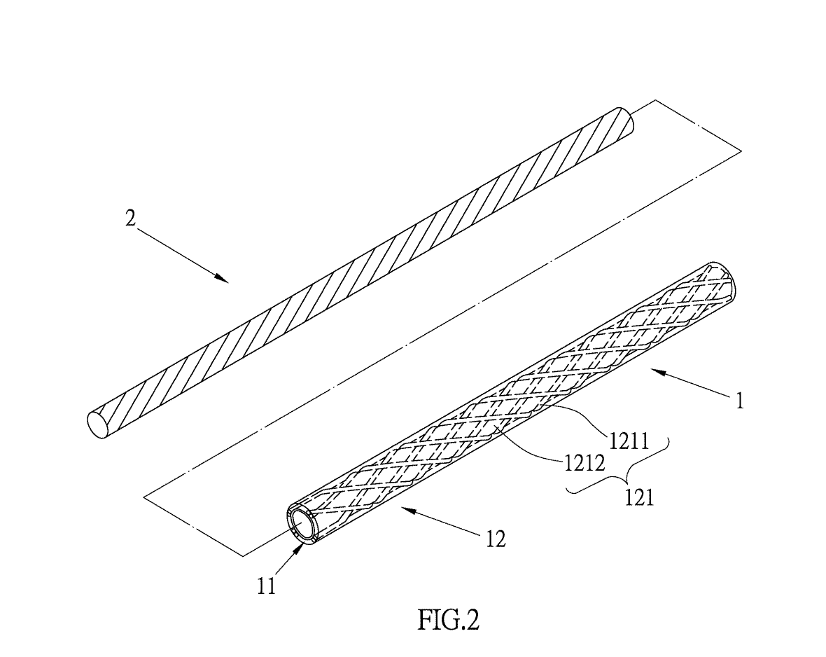

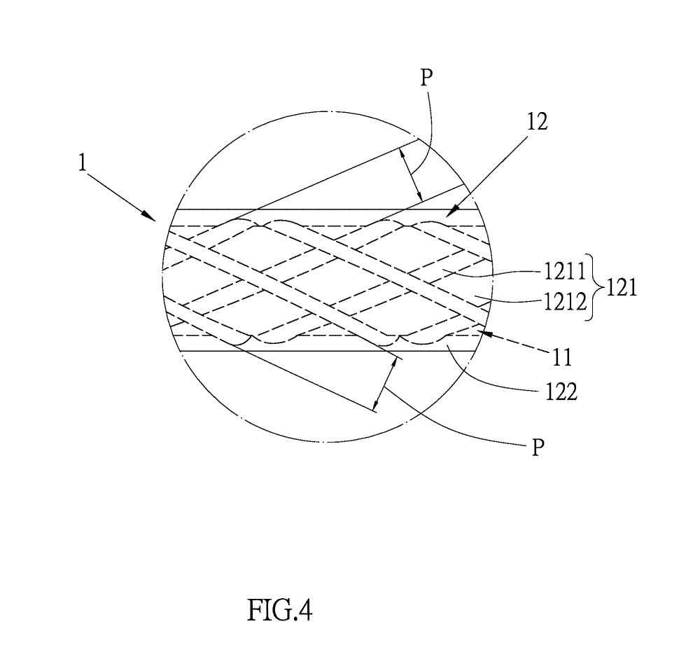

Referring to FIGS. 1 through 4, a cable 2 is inserted throughout a sheath 1 according to the preferred embodiment of the present invention. The sheath 1 includes a tubular lining 11 and a reinforcing tube 12. The tubular lining 11 is inserted in the reinforcing tube 12. The tubular lining 11 is made of a plastic material. Preferably, the tubular lining 11 is made of polyoxymethylene (“POM”) that is high in rigidity, light in weight, high in resistance against impacts and abrasion, and low in friction. The tubular lining 11 can be made of another plastic material depending on the usage.

The reinforcing tube 12 includes a tubular web 121 embedded in a tubular plastic layer 122. The tubular web 121 includes two groups of fibers 1211 extending on the tubular lining 11 in a helical manner. In each group, the fibers 1211 extend parallel to each other, and are evenly arranged on the tubular lining 11, i.e., any two adjacent fibers 1211 are separated by a gap P. The fibers 1211 in one of the groups intersect the fibers 1211 in the other group. Thus, the groups of fibers 1211 form the tubular web 121. The tubular 121 includes apertures 1212 defined by the fibers 1211. The fibers 1211 of the tubular web 121 are made of iron, steel, stainless steel, titanium alloy or copper.

The tubular web 121 is embedded in the tubular plastic layer 122 by inserting the tubular web 121 in a mold before the mold is filed with a plastic injection for example. The apertures 1212 are filled with the plastic material. Preferably, the plastic material is provided on the tubular lining 11 so that the reinforcing tube 12, which includes the tubular web 121 and the tubular plastic layer 122, is adhered to the tubular lining 11. Preferably, the tubular plastic layer 122 of the reinforcing tube 12 is made of a transparent or translucent plastic material. The tubular plastic layer 122 of the reinforcing tube 12 includes a gloss or matt surface for aesthetic purposes. The tubular plastic layer 122 is made of polypropylene (“PP”) or polyvinylchloride (“PVC”). The tubular plastic layer 122 can be made of any other proper plastic material.

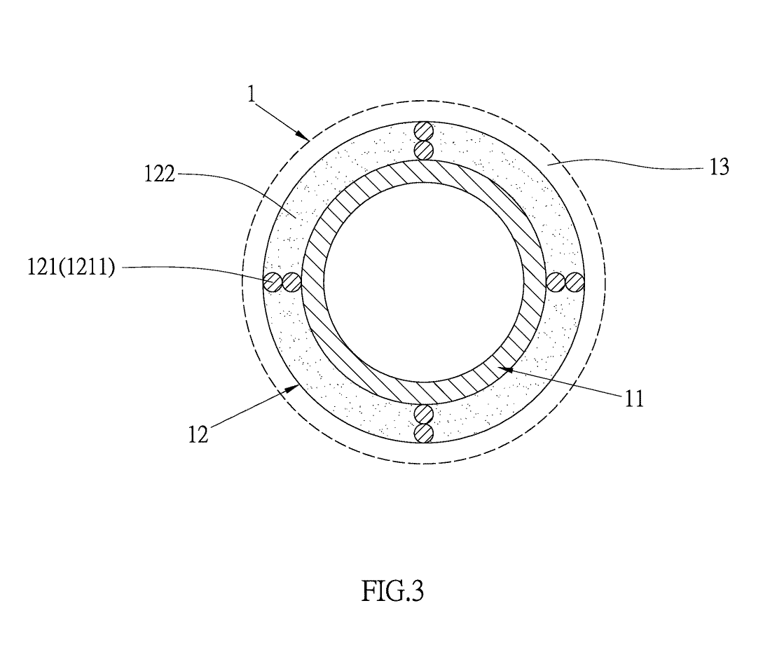

The sheath 1 further includes a tubular colored layer 13 as shown in broken lines in FIG. 3. The tubular colored layer 13 is provided on the tubular plastic layer 122 so that the sheath 1 exhibits a color instead of transparent or translucent.

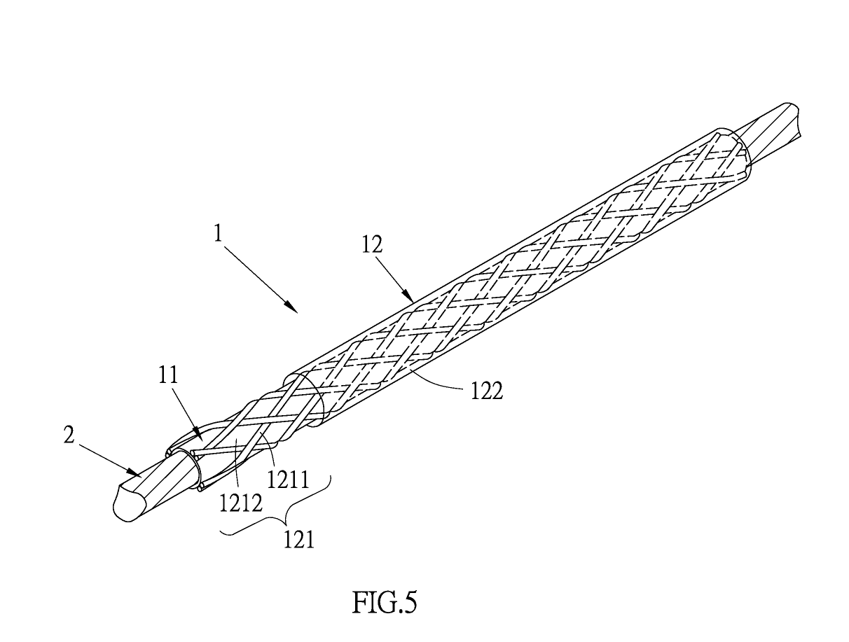

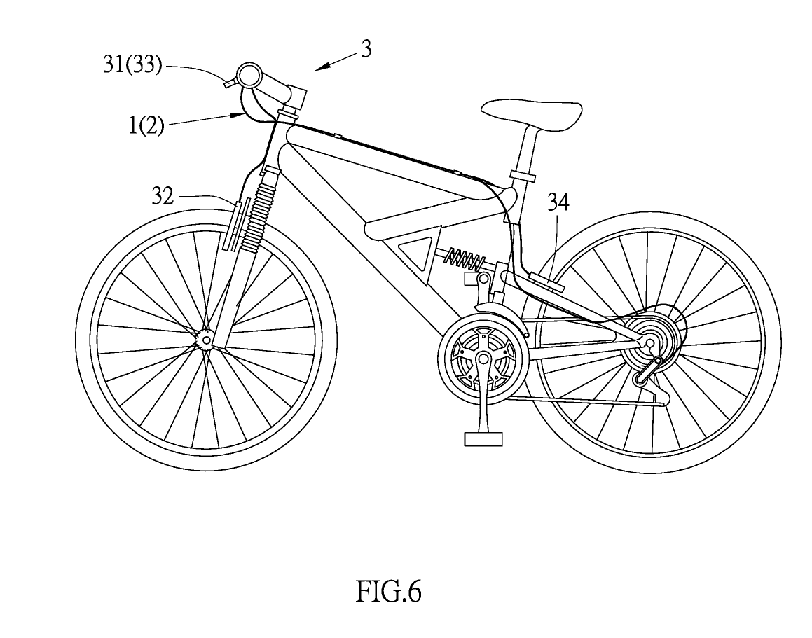

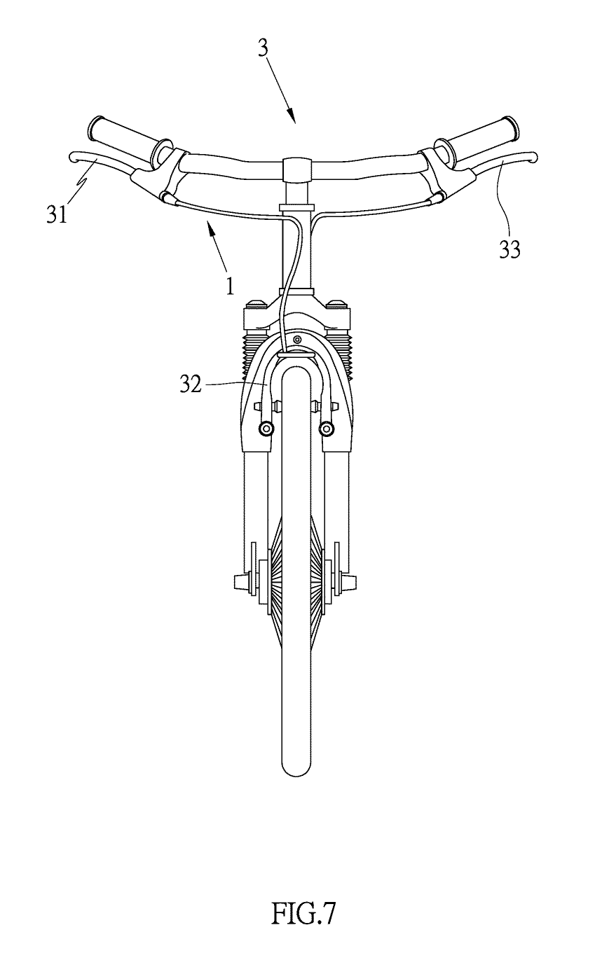

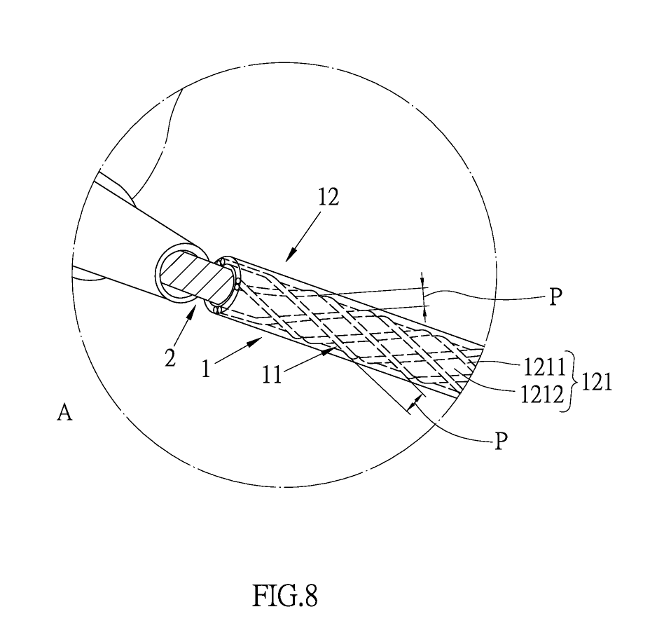

Referring to FIGS. 5 through 8, a bicycle 3 includes a braking system that includes a right brake lever 31, a front brake caliber 32, a left brake lever 33, a rear brake caliber 34, two cables 2 and several sheaths 1. One of the cables 2 is inserted in one of the sheaths 1, and includes an end connected to the right brake lever 31 and another end connected to the front brake caliber 32. The other cable 2 is inserted in the other sheaths 1, and includes an end connected to the left brake lever 31 and another end connected to the rear brake caliber 32. In particular, the cables 2 are inserted throughout the tubular linings 11 of the sheaths 1.

The right brake lever 31 is operable to pull the corresponding cable 2 in the corresponding sheath 1 to close the front brake caliber 32. The left brake lever 33 is operable to pull the corresponding cable 2 in the corresponding sheaths 1 to close the rear brake caliber 32. Thus, the bicycle 3 is slowed down.

The cables 2 slide in the sheaths 1 when the brake levers 31 and 32 are pulled. The cables 2 can smoothly slide in the tubular linings 11 because there is little friction between them because the cables 2 and the tubular linings 11, which are made of POM.

The sheaths 1 are longitudinally compressed when the cables 2 are pulled. Such longitudinal compression tends to reduce the length of each sheath 1 and enlarge the width of the sheath 1. However, the reduction of the length and the increase of the width of each sheath 1 are limited for at least three reasons. Firstly, the tubular plastic layer 122 holds the fibers 1211 of the tubular web 121 in position. Secondly, each of the fibers 1211 extends in a helical manner, and contributes to the longitudinal strength and transverse strength of each sheath 1. Thirdly, the fibers 1211 in one group intersect the fibers 1211 in the other group in each sheath 1 to avoid twist of the sheath 1. In addition to the excellent strength, the sheath 1 is light in weight for including a relatively small amount of layers.

Several sheaths 1 can be used in a derailing system that further includes two derailleurs, two switching levers, and two cables. Each switching lever is connected to a corresponding derailleur by a corresponding cable. Each cable is inserted in at least one sheath. Each switching lever is operable to pull the corresponding cable in the corresponding sheath(s) to activate the corresponding derailleur.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A sheath for a cable for a bicycle comprising:
a tubular lining;
a reinforcing tube provided on the tubular lining, wherein the reinforcing tube comprises a tubular plastic layer and a tubular web embedded in the tubular plastic layer, wherein the tubular web comprises two groups of helical fibers, wherein the fibers in one group intersect the fibers in the other group, thereby providing the tubular web with apertures, wherein the apertures of the tubular web are filled with a plastic material used to form the tubular plastic layer during the forming of the tubular plastic layer so that the tubular web is firmly held in position in the tubular plastic layer; and
a tubular colored layer provided on the tubular plastic layer.

2. The sheath according to claim 1, wherein the fibers in each group are evenly arranged on the tubular lining.

3. The sheath according to claim 2, wherein any two adjacent ones of the fibers are separated by a gap in each group.

4. (canceled)

5. The sheath according to claim 1, wherein the tubular plastic layer is adhered to the tubular lining

6. The sheath according to claim 1, wherein the fibers are made of a material selected from the group consisting of iron, steel, stainless steel, titanium alloy and copper.

7. The sheath according to claim 1, wherein the tubular plastic layer is made of a plastic material selected from the group consisting of a transparent plastic material and a translucent plastic material.

8. (canceled)

9. The sheath according to claim 1, wherein the tubular lining is made of a plastic material.
